(19) United States
(12) Patent Application Publication
(10) Pub. No.: US 2005/0278756 A1
(43) Pub. Date: Dec. 15, 2005

(54) Information processing apparatus featuring a multi-subsystem wireless bus architecture

(76) Inventor: Alan E. Brown, Georgetown, TX (US)

Correspondence Address: Mark P. Kahler, 8101 Vailview Cove, Austin, TX, 78750-7881, US

(21) Appl. No.: 10/866,635

(22) Filed: Jun. 12, 2004

(51) Int. Cl. H04N 7/173; H04N 7/18; G06F 12/00

(52) U.S. Cl. 725/80; 725/100; 725/131

(57) ABSTRACT

An information processing apparatus is disclosed including a processor subsystem that is shared among other subsystems via a wireless bus architecture. In one embodiment, the disclosed technology enables an information throughput improvement at the information bottleneck that can form at the processor as it attempts to communicate with subsystems.

### BACKGROUND

The disclosures in this document relate generally to information processing systems and more particularly to information processing systems which exhibit high bus bandwidths.

As society and its technology have progressed, the importance of information has become paramount. A literal explosion of information has occurred in the last few decades. Information processing systems which create, gather, manipulate, store and/or transfer information have become very important to both the maintenance of our current society and its future progress.

Information processing systems include one or more processors or engines to process the information flowing through such systems. One conventional processor employed in information processing systems is the Pentium 4 processor manufactured by Intel Corporation. The Pentium 4 is typically connected to a memory controller hub (MCH) by a multiple parallel wire conductor bus often called the front side bus (FSB). In one version, the FSB operates at 800 MHz to provide a 6.4 GB/sec transfer rate between the processor and the MCH. Three additional multiple parallel wire conductor bus groups are coupled to the MCH, namely a video data bus (VDB) connecting the MCH to a video controller, a memory bus (MB) connecting the MCH to system memory and another wire conductor bus (IOB) connecting the MCH to an I/O controller hub (ICH).

Presently, the upper frequency range employed by some multiple parallel wire conductor front side buses is within the 800-1066 MHz range. As processor technology progresses, higher and higher processor clock speeds are being reached. It is of course desirable that, when these higher processor clock speeds are attained, information transfer rates between the processor, system memory and other parts of the information processing system increase as well. Unfortunately, the increases in the information transfer rate between the processor and system memory and other parts of the system have not kept pace with processor speed increases. In fact a significant mismatch has developed.

More particularly, as the information processing industry evolves by attempting to achieve higher system memory access rates, greater video display data rates, faster local area network (LAN) communication rates, and other increasingly intensive data transfer activities, the conventional multiple parallel wire conductor front side bus has become a major bottleneck. This bottleneck is forcing system software/firmware to time share the multiple parallel conductor wire bus in a manner that naturally limits overall system performance while arbitrating this bus to stay within a frequency range much lower than the speed of the processor.

What is needed is a way to significantly increase the information handling capability of buses within an information processing system. Moreover, a way to eliminate or reduce information bottlenecks within an information processing system is likewise needed.

### SUMMARY

Accordingly, in one embodiment an information processing system is provided which includes a processor subsystem having a processor and a processor transceiver that is coupled to the processor. The processor transceiver wirelessly transmits and receives information for the processor. The system also includes a memory subsystem having a memory and a memory transceiver that is coupled to the memory. The memory transceiver wirelessly transmits information to and wirelessly receives information from the processor transceiver. In another embodiment, the system also includes a video subsystem having a video controller and a video transceiver that is coupled to the video controller. The video transceiver wirelessly transmits information to and wirelessly receives information from the processor transceiver. In this manner, the processor of the processor subsystem is shared between the memory subsystem and the video subsystem. In another embodiment, a method is provided for operating an information processing system which includes sharing a processor subsystem among a plurality of other subsystems by the processor subsystem wirelessly transmitting to, and wirelessly receiving information, the other subsystems.

### BRIEF DESCRIPTION OF THE DRAWINGS

FIG. 1 is a block diagram of conventional information processing system employing a multiple parallel wire conductor bus.

FIG. 2 is a block diagram of one embodiment of the disclosed information processing system.

FIG. 3 is a representation of a message sent from one subsystem to another subsystem in the disclosed information processing system.

FIG. 4 is a block diagram of another embodiment of the disclosed information processing system.

### DETAILED DESCRIPTION

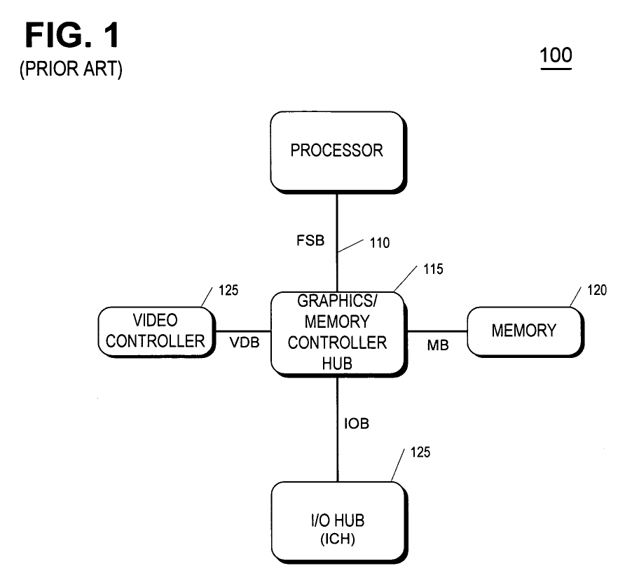

FIG. 1 depicts a high level block diagram of a conventional information processing system 100 which manifests the bus bottleneck problems discussed earlier. System 100 includes a processor 105, such as an Athlon (Athlon is a trademark of AMD) or Pentium class microprocessor, coupled via front side bus (FSB) 110 to a graphics/memory controller hub 115. Hub 115 is coupled to both a system memory 120 and a video graphics controller 125. Graphics/memory hub 115 is also coupled to an I/O controller hub 125 that facilitates input/output operations. It is thus seen that front side bus 110 is directly burdened with the communications demands of 3 major generators/consumers of information, namely memory 120, video controller 125 and I/O controller hub 125. This heavy burden on FSB 110 creates the aforementioned undesirable bottleneck situation. Memory, video and I/O operations are impeded by the bottleneck in FSB 110.

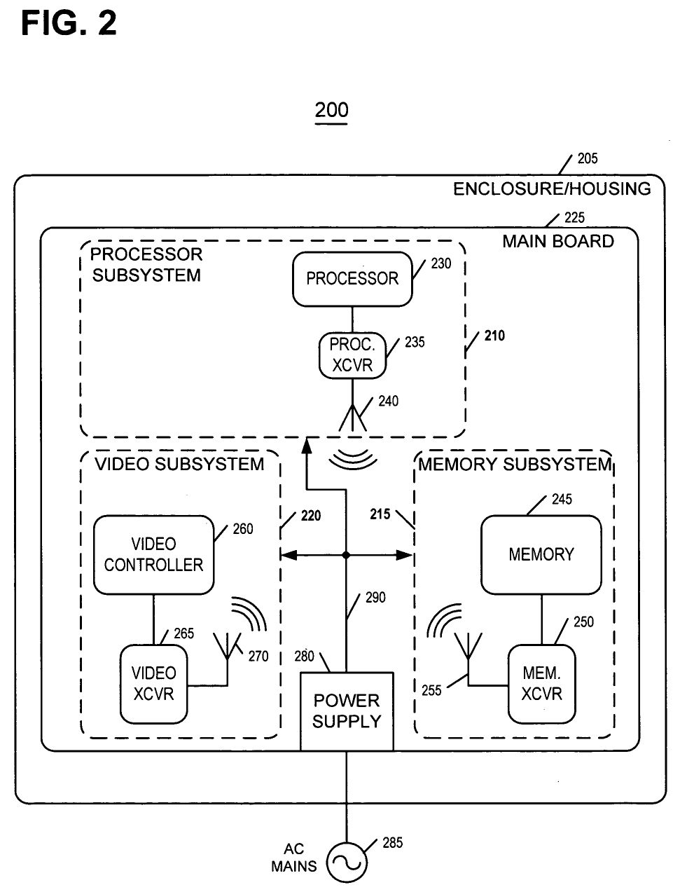

FIG. 2 is a block diagram of an information processing system or apparatus 200 which includes an enclosure or housing 205 for housing the components of the system which are now described. Information processing system 200 includes a processor subsystem 210, a memory subsystem 215 and a video graphics subsystem 220 all situated on a main circuit board 225 which is called a motherboard in some applications. Alternatively, processor subsystem 210, memory subsystem 215 and video graphics subsystem 220 are situated on respective boards within housing 205. However, whether the subsystems are situated on a common main board or respective boards, or a combination thereof, or in a backplane arrangement, it is important that these subsystems be located sufficiently close to one another that they can transmit and receive wireless radio frequency signals to and from one another. In one embodiment, the wireless signals are controlled to exhibit a limited amplitude that is selected to be sufficiently low that the wireless signals will remain substantially inside of housing 205. At the same time, the amplitude of the wireless radio frequency signals is selected to be sufficiently large that that the subsystems can communicate with one another with an acceptably low information error rate. The output powers of the transceivers are selected to achieve these ends.

Processor subsystem 210 includes a processor 230 which is coupled to a processor transceiver 235. Processor transceiver 235 is coupled to an antenna 240 to enable processor transceiver 235 to transmit wireless radio frequency signals to other subsystems and to receive wireless radio frequency signals from other subsystems.

Memory subsystem 215 includes a memory 245 which is coupled to a memory transceiver 250. Memory transceiver 250 is coupled to an antenna 255 to enable memory transceiver 250 to transmit wireless radio frequency signals to other subsystems and to receive wireless radio frequency signals from other subsystems.

Video graphics subsystem 220 includes a video controller 260 which is coupled to a video transceiver 265. Video transceiver 265 is coupled to an antenna 270 to enable video transceiver 265 to transmit wireless radio frequency signals to other subsystems and to receive wireless radio frequency signals from other subsystems. Video subsystem 260 is coupled to a display (not shown) so that information can be displayed to a user of information processing system 200.

In one embodiment processor subsystem 210, memory subsystem 215 and video subsystem 220 all transmit on the same channel or radio frequency with priority being given to transmissions from processor subsystem 210. Memory subsystem 215 and video subsystem 220 each periodically listen on the channel to determine if a transmission is incoming from processor subsystem 210 and if so, the memory and video subsystems do not transmit during the time that processor subsystem 210 is transmitting. Each transmission or group of transmissions from a subsystem begins with a preamble, header or address that is unique to that subsystem. In this manner, when processor subsystem 210 is transmitting, other subsystems know to avoid transmitting and to listen for an information transmission from processor subsystem 210. The preamble information informs other subsystems regarding which particular subsystem is currently transmitting and further includes information regarding which particular subsystem is the intended target. For example, the preamble can include the “source address” of the transmitting subsystem and the address of a “target address” of a particular target subsystem.

System 200 includes a power supply 280 which is coupled to the AC mains 285. Power supply 280 provides processor subsystem 210, memory subsystem 215 and videos subsystem 220 with electrical energy via power conductors 290 coupled between power supply 280 and the subsystems as shown.

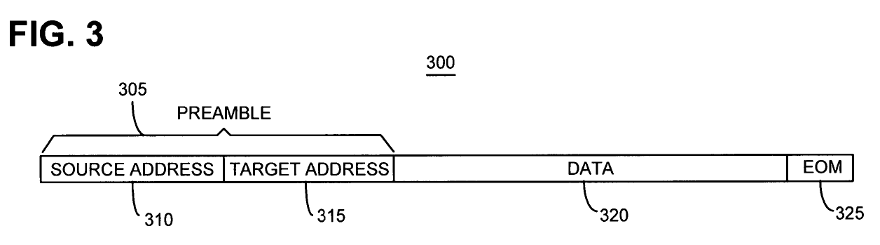

FIG. 3 is a representation of a message 300 sent from one subsystem to another subsystem in information processing system 200. Message 300 begins with a preamble 305 which includes the source address 310 of the source subsystem which is sending the message followed by the target address 315 of the target subsystem for which the message is intended. When a particular subsystem receives a target address corresponding to that subsystem's address, then that subsystem receives the data 320 following the target address. Other non-target subsystems may ignore the data following the target address. The end of a transmission to the subsystem at the particular target address is indicated by an end of message marker (EOM) 325. The data transmission protocol shown in FIG. 3 is one example of a data protocol that can be used to send data messages among the subsystems of the information processing system. It should be noted however that many other data transmission protocols can be used as well and are considered to be within the scope of this disclosure. For example, the length of data block 320 may be fixed, or alternatively, it may be varied depending upon the particular application.

In a variation of the above described embodiment, transmissions from processor subsystem 210 to memory subsystem 215 are on the same channel or frequency, F1, as transmissions from memory subsystem 215 to processor subsystem 210. For example, processor transceiver 235 transmits information from processor 230 to memory subsystem 215 on a particular channel, F1, and memory subsystem 215 acknowledges reception back to processor 230 on the same channel, F1. If desired, the acknowledge back can be omitted if slightly reduced reliability is acceptable. Memory subsystem 215 transmits the requested information back to processor subsystem 210 on the same channel, F1, as processor 230's requests for that information. Table 1 below illustrates the frequencies employed by the processor and memory subsystems in this embodiment.

TABLE 1

| | Frequency |
|---|---|
| Processor to Memory | F1 |
| Memory to Processor | F1 |

In actual practice, memory subsystem 215 may includes a memory controller for translating requests for information in memory 245 to actual addresses from which information can be fetched from memory 245.

In another embodiment, transmissions from processor subsystem 210 to memory subsystem 215 and transmissions from memory subsystem 215 to processor subsystem 210 are on different channels or frequencies. For example, processor transceiver 235 transmits information from processor 230 to memory subsystem 215 on a particular channel, F1, and memory subsystem 215 acknowledges reception back to processor 230 on a different channel, F2. Memory subsystem 215 transmits requested information back to processor subsystem 210 on the different channel, F2, than processor 230 used to transmit the request for that information. Table 2 below illustrates the frequencies employed by the processor and memory subsystems in this embodiment.

TABLE 2

| | Frequency |
|---|---|
| Processor to Memory | F1 |
| Memory to Processor | F2 |

In another embodiment, transmissions from processor subsystem 210 to video subsystem 220 are on the same channel or frequency as transmissions from video subsystem 220 to processor subsystem 210. For example, processor transceiver 235 transmits information from processor 230 to video subsystem 220 on a particular channel, F3, and video subsystem 220 acknowledges reception back to processor 230 on the same channel, F3. Video subsystem 220 can also transmit information to processor subsystem 210 on the same channel that processor subsystem 210 used to transmit information to video subsystem 220. Table 3 below illustrates the frequencies employed by the processor and video subsystems in this embodiment.

TABLE 3

| | Frequency |
|---|---|
| Processor to Video | F3 |
| Video to Processor | F3 |

It is noted that processor subsystem 210 can be outfitted to operate on multiple frequencies so that it can conduct communications with video subsystem 220 on frequency, F3, while also conducting communications with memory subsystem 215 on frequency, F1 or F2.

In another embodiment, transmissions from processor subsystem 210 to video subsystem 220 and transmissions from memory subsystem 215 to processor subsystem 210 are on different channels or frequencies, F3 and F4, respectively. For example, processor transceiver 235 transmits information from processor 230 to video subsystem 220 on a particular channel, F3, and video subsystem 220 acknowledges reception back to processor 230 on the different channel, F4. In some applications, the acknowledge back can be omitted. Information such as status information and/or video characteristics information is transmitted by video subsystem 220 to processor subsystem 210 on a different frequency or channel, namely F4, than processor subsystem 210 used to transmit information to video subsystem 220, namely F3. Table 4 below illustrates the frequencies employed by the processor and video subsystems in this embodiment.

TABLE 4

| | Frequency |
|---|---|
| Processor to Video | F3 |
| Video to Processor | F4 |

While memory subsystem 215 can transmit requested information to processor subsystem 210 and processor subsystem 210 can then relay the information to another subsystem, one embodiment enables the direct transmission of information from one subsystem to another subsystem without going through processor subsystem 210. For example, in one embodiment, memory subsystem 215 can transmit information directly to video subsystem 220 without first going through processor subsystem 210. In that embodiment, representative arrangements of the channels or frequencies that can be employed are given in Tables 5 and 6 below.

TABLE 5

| | Frequency |
|---|---|
| Processor to Memory | F1 |
| Memory to Processor | F1 |
| Processor to Video | F2 |
| Video to Processor | F2 |
| Memory to Video | F3 |
| Video to Memory | F3 |

It is seen that in the channel frequency arrangement of Table 5, information is transmitted directly from memory subsystem 215 to video subsystem 220 on channel F3 without being passed through processor subsystem 230. It is however still possible for memory subsystem 215 to transmit information to processor subsystem 210 on channel F1 and then the processor subsystem can pass that information, either modified or unmodified, to video subsystem 220 via channel F2.

TABLE 6

| | Frequency |
|---|---|
| Processor to Memory | F1 |
| Memory to Processor | F2 |
| Processor to Video | F3 |
| Video to Processor | F4 |
| Memory to Video | F5 |
| Video to Memory | F6 |

Alternatively, as seen in the channel frequency arrangement of Table 6, information is transmitted directly from memory subsystem 215 to video subsystem 220 on channel F5 without being passed through processor subsystem 230. It is however still possible for memory subsystem 215 to transmit information to processor subsystem 210 on channel F2 and then processor subsystem 210 can pass that information, either modified or unmodified, to video subsystem 220 via channel F3.

In actual practice, when a particular subsystem such as the video subsystem operates on multiple frequencies or channels, that subsystem will be outfitted with a number of transmitters and receivers (transceivers) and antennas appropriate for such transmission and reception. For example in the arrangement depicted in Table 6 wherein memory subsystem 215 transmits on frequencies or channels F2 and F5 and receives on frequencies or channels F1 and F6, the memory subsystem includes 2 transceivers, each transceiver being capable of transmitting on one frequency and receiving on another to provide duplex operation. In such a duplex operational mode, a transceiver can be transmitting information on one frequency and receiving information on another frequency at the same time.

As seen in FIG. 2, memory subsystem 215 and video subsystem 220 share processor 230 in processor subsystem 210. Since processor 230 effectively has 2 ports though which to transmit and receive information, the undesirable bottleneck effect exhibited by prior systems is effectively ameliorated in this embodiment.

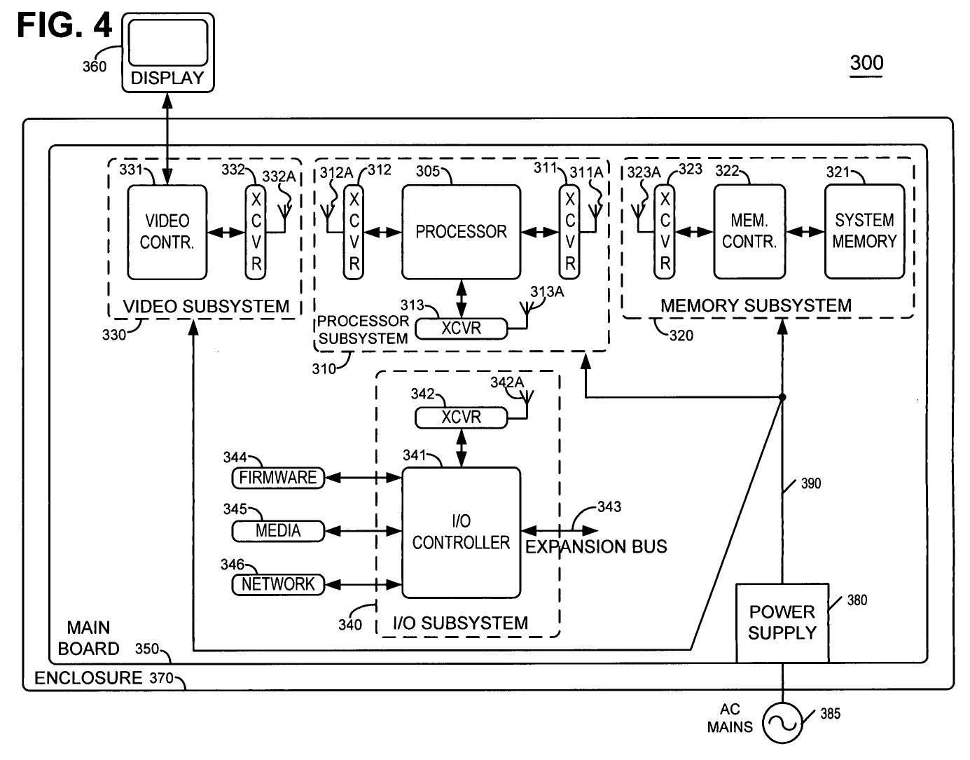

FIG. 4 is a block diagram of an information processing system 300 including a processor subsystem 310 with transceivers 311, 312 and 313 dedicated to communicating with respective subsystems, namely memory subsystem 320, video subsystem 330 and I/O subsystem 340. Processor subsystem 310 includes a processor 305 which is coupled to transceivers, 311, 312 and 313. A simplex embodiment is now described using the topology shown in FIG. 4 and is explained with reference to TABLE 7 below.

TABLE 7

| | Frequency |
|---|---|
| Processor XCVR 311 to | F1 |
| Memory | |
| Memory to | F1 |
| Processor XCVR 311 | |
| Processor XCVR 312 to | F2 |
| Video | |
| Video to | F2 |
| Processor XCVR 312 | |
| Processor XCVR 311 to I/O | F3 |
| I/O to | F3 |
| Processor XCVR 311 | |

In processor subsystem 310, memory transceiver 311 is coupled to an antenna 311A, video transceiver 312 is coupled to an antenna 312A, and I/O transceiver 313 is coupled to an antenna 313A. Memory transceiver 311 transmits information to and receives information from memory subsystem 320. Memory subsystem 320 includes system memory 321 which is coupled to a memory controller 322. Memory controller 322 is coupled to a memory transceiver 323 which in turn is coupled to an antenna 323A so that memory subsystem 320 can transmit information from memory 321 to processor subsystem 310. Referring to Table 7, it is seen that processor subsystem 310 and memory subsystem 320 communicate with each other in a simplex mode wherein their respective memory transceivers 311 and 323 transmit on the same frequency or channel, namely, F1. In this embodiment, memory transceivers 311 and 323 do not transmit at the same time, but rather their transmissions are staggered or otherwise offset in time so that they do not interfere with each other.

Referring again to processor subsystem 310 in FIG. 4, video transceiver 312 transmits information to and receives information from video subsystem 330. Video subsystem 330 includes a video controller 331 which is coupled to video transceiver 332. Video transceiver 332 is coupled to an antenna 332A. This enables video subsystem 330 to transmit information to and receive information from processor subsystem 310. In this particular embodiment video subsystem 330 is coupled to an external display 360. This may be achieved by a wired or wireless connection between the video subsystem 330 and display 360. Referring to Table 7, it is seen that processor subsystem 310 and video subsystem 330 communicate with each other in a simplex mode wherein their respective video transceivers 312 and 332 transmit on the same frequency or channel, namely, F2. In this embodiment, video transceivers 312 and 332 do not transmit at the same time, but rather their transmissions are staggered or otherwise offset in time so that they did not interfere with each other.

Referring again to processor subsystem 310 in FIG. 4, an I/O transceiver 313 transmits information to and receives information from I/O subsystem 340. I/O subsystem 340 includes an I/O controller 341 which is coupled to an I/O transceiver 342. An I/O transceiver 342 is coupled to an antenna 342A such that I/O subsystem 340 can send I/O information to and receive I/O information from processor subsystem 310. Referring to Table 7, it is seen that processor subsystem 310 and I/O subsystem 340 communicate with each other in a simplex mode wherein their respective I/O transceivers 313 and 342 transmit on the same frequency namely F3. In this embodiment, it is noted that I/O transceivers 313 and 342 do not transmit at the same time, but rather their transmissions are staggered or otherwise offset in time so that they do not interfere with each other.

As seen in the embodiment described above, memory transceiver 311 is in simplex operation with respect to memory transceiver 323, and video transceiver 312 is in simplex operation with respect to video transceiver 332, and I/O transceiver 313 is in simplex operation with respect to I/O transceiver 342. Within each transceiver pair above, the transmissions are simplex so that they are staggered or otherwise do not overlap in time. However, one transceiver pair, for example memory transceiver pair 311, 323 may be communicating at the same time that video transceiver pair 312, 332 are communicating. Moreover, it is also contemplated that I/O transceiver pair 313, 342 may be transmitting at the same time the above two mentioned transceiver pairs are transmitting. This arrangement significantly increases the overall throughput, flexibility and efficiency of the system. It will thus be appreciated that, in one embodiment, memory subsystem 320, video subsystem 330 and I/O subsystem 340 share processor subsystem 310 in a manner that permits substantially higher information throughput than conventional systems.

In more detail, I/O subsystem 340 includes an expansion bus 343. Expansion bus 343 enables the functionality of system 300 to be augmented or expanded through the use of plug-in or expansion cards. Examples of expansion buses which may be employed as expansion bus 343 include one or more of the PCI bus, the PCIE bus, SATA bus, the IEEE 1394 bus, USB, IDE bus, ATA bus as well as other present and future bus standards. Firmware 344, such as a basic input output system (BIOS) on Flash or other memory is coupled to I/O controller 341 as shown to govern the operation of system 300. One or more fixed or removable media devices 345 are coupled to I/O subsystem 340 as shown. Media devices provide nonvolatile storage to the system. An operating system is stored on one of such devices 345 to control the operation of the system along with firmware 344. Application software and other information can also be stored on media devices 345. A network controller 346 is coupled to I/O subsystem 340 so that system 300 can be connected to an external network by a wired connection or wirelessly.

A duplex embodiment of system 300 is now described using the topology shown in FIG. 4 and explained with reference to TABLE 8 below.

TABLE 8

| | Frequency |
|---|---|
| Memory XCVR 311 to | F1 |
| Memory XCVR 323 | |
| Memory XCVR 323 to | F2 |
| Memory XCVR 311 | |
| Video XCVR 312 to Video | F3 |
| XCVR 332 | |
| Video XCVR 332 to | F4 |
| Video XCVR 312 | |
| I/O XCVR 313 to | F5 |
| I/O XCVR 342 | |
| I/O XCVR 342 to | F6 |
| I/O XCVR 313 | |

In a duplex embodiment of system 300, memory transceiver 311 transmits information to memory transceiver 323 on a channel F1. Memory transceiver 323 transmits information to memory transceiver 311 on a channel F2. Memory transceiver 311 listens for transmissions on channel F2 and memory transceiver 323 listens for transmissions on channel F1. Thus, memory transceiver pair 311,323 can be transmitting and receiving information at the same time since different channels are used for each function. This permits the rapid transfer of information between processor subsystem 310 and memory subsystem 320.

Also, in one embodiment, memory transceiver 312 transmits information to video transceiver 332 on a channel F3. Video transceiver 332 transmits information to video transceiver 312 on a channel F4. In this arrangement, video transceiver 312 listens for transmissions on channel F4 and video transceiver 332 listens for transmissions on channel F3. This permits the rapid transfer of information between processor subsystem 310 and video subsystem 330.

And finally, I/O transceiver 313 transmits information to I/O transceiver 342 on a channel F5. I/O transceiver 342 transmits information to I/O transceiver 313 on a channel F6. In this arrangement, I/O transceiver 313 listens for transmissions on the channel F6 and I/O transceiver 342 listens for transmissions on channel F5. It is thus seen that, in one embodiment, full duplex operation is achieved wherein memory transceiver pair 311, 323, video transceiver pair 312, 332 and I/O transceiver pair 313, 342 can all be transmitting and receiving simultaneously within a transceiver pair and also with respect to other transceiver pairs. Thus, duplex on duplex operation is achieved in one or more embodiments.

System 300 includes a power supply 380 which is coupled to the AC mains 385. Power supply 380 provides processor subsystem 310, memory subsystem 320, video subsystem 330 and I/O subsystem 340 with electrical energy via power conductor bus 390 coupled between power supply 380 and the subsystems as shown. As few as two wires may be employed in power bus 390 to supply electrical energy to the subsystems.

As seen in FIG. 4, memory subsystem 320, video subsystem 330 and I/O subsystem 340 share processor 305 of processor subsystem 310. Since processor 305 effectively has 3 ports though which to transmit and receive information, the undesirable bottleneck effect exhibited by prior systems is substantially ameliorated in this embodiment.

In one embodiment, processor subsystem 310, memory subsystem 320, video subsystem 330 and I/O subsystem 340 are situated on a main board 350. In another embodiment, the subsystems are situated on respective boards which plug-in to a main board which interconnects the subsystems. In such a plug-in arrangement, the plug-in connectors for the subsystem cards do not need an intricate wire information bus structure with a large number of parallel conductors that are typically used to transmit data, but rather can be simple connectors appropriate for connecting power to the plug-in cards. The wireless communication capabilities already described provide communication of information among such plug-in cards without using a wire communication bus.

Likewise, in the embodiment already described wherein the subsystems are situated on a main board, a multiple conductor wire bus is not required to provide information communication among the subsystems. Rather just a power supply connection is needed to source power to the subsystems and this power supply connection can have as few as two conductors feeding the various subsystems.

The above described wireless communication technique is used to enable the subsystems to communicate without the need for the conventional multiple parallel conductor information bus and the consequence of bottlenecks. In one embodiment, all the subsystems are situated within an enclosure 370 and the RF radiations from the various transceivers are substantially contained within enclosure 370. To assist in the containment of the RF signals within enclosure 370, enclosure 370 can be fabricated from a metallic case material or a metal-lined plastic case material or other material which can substantially contain an RF field. The case can take the form of a Faraday cage to substantially confine the RF signals to inside the housing or enclosure 370. As mentioned earlier, to assist in containing the RF field within enclosure 370, the transmit power employed by the transceivers in the system can be a very low level, for example in the milliwatt range or even the microwatt level in one embodiment. In the topology shown in FIG. 4, the four antennas may be positioned very close to one another, for example millimeters or centimeters from one another, in one embodiment, to enable communication at very low power levels within the milliwatt or even the microwatt ranges. Of course greater or lesser RF power levels can be employed depending upon the particular application and the amount of shielding provided by enclosure 370.

It will thus be appreciated that one embodiment of the disclosed technology achieves true wireless operation in that the subsystems of the system communicate with each other wirelessly, i.e. without of the use of wire, wire waveguides or other wire structures to conduct the RF signals from one subsystem to another subsystem. Omni directional or directional antennas can be employed to transmit RF signals between subsystems. The transmit power needed to communicate between transceivers in a transceiver pair can be reduced by using antennas with gain. Directional antennas can be employed between transceivers in a transceiver pair to reduce the RF power needed to transmit information between transceivers in a transceiver pair. These directional antennas in a transceiver pair can be aimed at one another to enhance communication therebetween.

The transceivers in the above described transceiver pairs can employ different types of modulation, for example TDMA, CDMA, OFDM, PSK, QPSK, AM, FM, PM, UWB, spread spectrum, as well many other types of modulation. In one embodiment, a particular transceiver pair may use one type of modulation whereas another transceiver pair may use a different type of modulation. It is also contemplated that within a particular transceiver pair a mixed mode modulation scheme may be employed wherein a particular transmitter may use one type of modulation to communicate with a particular receiver, whereas the other transmitter and receiver in the transceiver pair may use another type of modulation.

Although illustrative embodiments have been shown and described, a wide range of modification, change and substitution is contemplated in the foregoing disclosure and in some instances, some features of an embodiment may be employed without a corresponding use of other features. Accordingly, it is appropriate that the appended claims be construed broadly and in a manner consistent with the scope of the embodiments disclosed herein.

1. An information processing system comprising:
a processor subsystem including
a processor;
a processor transceiver, coupled to the processor, that wirelessly
transmits and receives information for the processor; and
a memory subsystem including
a memory;
a memory transceiver, coupled to the memory, that wirelessly transmits information to and wirelessly receives information from the processor transceiver.

2. The information processing system of claim 1 including a wire power bus coupled to the processor subsystem and the memory subsystem to provide power thereto.

3. The information processing system of claim 1 wherein the processor transceiver and the memory transceiver transmit on a first wireless channel.

4. The information processing system of claim 1 wherein the processor transceiver and the memory transceiver transmit on a plurality of wireless channels therebetween.

5. The information processing system of claim 1 including a video subsystem including a video transceiver that wirelessly transmits information to and wirelessly receives information from the processor transceiver such that the memory subsystem and the video subsystem share the processor.

6. The information processing system of claim 5 wherein the memory transceiver and the processor transceiver transmit on a first plurality of channels therebetween and the video transceiver and the processor transceiver transmit on a second plurality of channels therebetween.

7. The information processing system of claim 1 including an I/O subsystem including an I/O transceiver that wirelessly transmits information to and wirelessly receives information from the processor transceiver such that the memory subsystem and the I/O subsystem share the processor.

8. The information processing system of claim 5 including an I/O subsystem including an I/O transceiver that wirelessly transmits information to and wirelessly receives information from the processor transceiver such that the memory subsystem, the video subsystem and the I/O subsystem share the processor.

9. The information processing system of claim 8 wherein the memory transceiver and the processor transceiver transmit on a first plurality of channels therebetween, and the video transceiver and the processor transceiver transmit on a second plurality of channels therebetween, and the I/O transceiver and the processor transceiver transmit on a third plurality of channels therebetween.

10. The information processing system of claim 1 wherein a processor antenna is coupled to the processor transceiver.

11. The information processing system of claim 10 wherein a memory antenna is coupled to the memory transceiver.

12. The information processing system of claim 5 wherein a processor antenna is coupled to the processor transceiver, a memory antenna is coupled to the memory transceiver and a video antenna is coupled to the video transceiver.

13. The information processing system of claim 8 wherein a processor antenna is coupled to the processor transceiver, a memory antenna is coupled to the memory transceiver, a video antenna is coupled to the video transceiver and an I/O antenna is coupled to the I/O transceiver.

14. A method of operating an information processing system comprising:
sharing a processor subsystem among a plurality of other subsystems by the processor subsystem wirelessly transmitting to, and wirelessly receiving information, the other subsystems.

15. The method of claim 14 wherein the plurality of subsystems includes a video subsystem.

16. The method of claim 14 wherein the plurality of subsystems includes a memory subsystem.

17. The method of claim 14 wherein the plurality of subsystems includes an I/O subsystem.

18. The method of claim 14 including wirelessly transmitting, by the other subsystems, information to the processor subsystem

19. The method of claim 14 including wirelessly exchanging information directly between at least two of the other subsystems.

20. The method of claim 14 including wirelessly exchanging information directly between at least two of the other subsystems without first transmitting the information to the processor subsystem.

21. The method of claim 14 including wirelessly transmitting information directly from one of the other subsystems to another of the other subsystems.

22. The method of claim 14 including wirelessly transmitting information directly from one of the other subsystems to another of the other subsystems without first transmitting the information to the processor.

23. The method of claim 14 wherein the processor subsystem and one of the other subsystems communicate with each other over the same radio frequency channel.

24. The method of claim 14 wherein the processor subsystem transmits information to a first subsystem on a first radio frequency channel and the first subsystem transmits information to the processor subsystem on the first radio frequency channel.

25. The method of claim 14 wherein the processor subsystem transmits information to a first subsystem on a first radio frequency channel and the first subsystem transmits information to the processor subsystem on a second radio frequency channel.

26. The method of claim 24 wherein the processor subsystem transmits information to a second subsystem on a second radio frequency channel and the second subsystem transmits information to the processor subsystem on the second radio frequency channel.

27. The method of claim 25 wherein the processor subsystem transmits information to a second subsystem on a third radio frequency channel and the second subsystem transmits information to the processor subsystem on a fourth radio frequency channel.

28. The method of claim 26 wherein the first subsystem transmits information directly to the second subsystem on a third radio frequency channel.

29. The method of claim 27 wherein the first subsystem transmits directly to the second subsystem on a fifth radio frequency channel and the second subsystem transmits information directly to the first subsystem on a sixth radio frequency channel.
